(19) United States
(12) Patent Application Publication
(10) Pub. No.: US 2014/0117929 A1
(43) Pub. Date: May 1, 2014

(54) Assemblage for inductive energy transfer to an electrically drivable vehicle

(71) Applicant: Thomas LANG, Reutlingen (DE)

(72) Inventor: Thomas LANG, Reutlingen (DE)

(73) Assignee: Robert Bosch GmbH, Stuttgart (DE)

(21) Appl. No.: 14/061,860

(22) Filed: Oct. 24, 2013

(30) Foreign Application Priority Data
Oct. 26, 2012 (DE) 10 2012 219 673.0

(51) Int. Cl. B60L 11/18

(52) U.S. Cl. CPC B60L 11/182
USPC 320/108; 307/9.1

(57) ABSTRACT

An assemblage for inductive energy transfer to an electrically drivable vehicle is proposed, which assemblage encompasses a secondary coil and a first signal processing unit. The first signal processing unit is configured to process energy received from the secondary coil, and the assemblage is configured to dispose the secondary coil and a tubular frame portion of the vehicle coaxially with one another, coupling of the secondary coil and the tubular frame section with good thermal conductivity being achieved.

### RELATED APPLICATION INFORMATION

The present application claims priority to and the benefit of German patent application no. 10 2012 219 673.0, which was filed in Germany on Oct. 26, 2012, the disclosure of which is incorporated herein by reference.

### FIELD OF THE INVENTION

The present invention relates to an assemblage for inductive energy transfer to an electrically drivable vehicle. The present invention relates in particular to an easily integratable and contamination-resistant assemblage.

### BACKGROUND INFORMATION

Rechargeable-battery-operated electric vehicles of open design (e.g. electric bicycles, electric scooters, lawnmowers, etc.) known in the existing art usually require charging systems that obtain their energy via a 230 V grid. A constituent of these charging devices, besides the power supply section, is a DC/DC converter that converts the line voltage to the charging voltage (e.g. 40 V). So-called resonance converters, which are also known as power supply sections of laptops, are often used as DC/DC converters. For a rated power output of 100 to 200 W, these devices have dimensions of, for example, 160×50×40 mm, which corresponds to a volume of 0.32 l. The known devices weigh approximately 500 g. These charging devices are usually supplied as separate components that have cable connectors both to the energy supply grid and to the vehicle-side rechargeable battery. An essential constituent of such devices is a transfer unit (transformer) that, as an inductive converter, creates the necessary voltage ratio between the primary side and second side. It is, however, inconvenient for the user to acquire and carry separate power supply devices. A charging operation requires the simultaneous creation of several electrical connections that can easily become contaminated and exhibit contacting faults. The known charging systems have several disadvantages on the developer side as well.

On the one hand, plug connections must be made to rechargeable batteries that may be located inside the bodywork or inside the vehicle, and passthroughs for these must be provided which create pathways for moisture and contaminants into the vehicle frame. On the other hand, integration of the known charging devices into known vehicle frames is not readily possible because of the large volume of the converter. The volume of the known converter units is determined, for example, by the physical size of the transformer, cooling plates, cooling fins, and capacitors. In addition, retrofitting or conversion of these conventional charging systems to contactless energy transfer, in order to increase user acceptance, is not possible. Furthermore, the weight distribution of a conventional charging device is predefined by the manufacturer or governed by the design, so there is little or no opportunity to influence the center-of-gravity optimization of a vehicle equipped with the charging device. Lastly, adaptation of the power transfer parameters between the primary and secondary sides is usually also not possible with conventional systems, since all the components are disposed in a sealed housing.

### SUMMARY OF THE INVENTION

The aforementioned disadvantages of the existing art are eliminated according to the present invention by an assemblage having the features according to the description herein, and by an electrically drivable vehicle having the features according to further description herein.

An assemblage according to the present invention for inductive energy transfer to an electrically drivable vehicle accordingly has a secondary coil and a first signal processing unit. The secondary coil is provided in order to receive energy inductively and convey it via electrical leads to the first signal processing unit. In the signal processing unit, the received alternating signals can be processed, i.e. for example rectified, and delivered to an energy reservoir (e.g. an electrochemical energy reservoir). The first signal processing unit has for this purpose a rectifier. The assemblage is furthermore configured according to the present invention to dispose the secondary coil and a tubular frame portion of the vehicle coaxially with one another, and to couple the two to one another with good thermal conductivity. This can be done, for example, by way of a substantially direct attachment of the coil (electrically insulated, of course, with respect to the frame) on the tubular frame portion. Alternatively or additionally, heat transfer agents such as thermoconductive pastes can be provided between the tubular frame portion and the secondary coil.

The further descriptions herein present refinements of the exemplary embodiments of the present invention.

The secondary coil can be configured to be disposed inside the tubular frame portion. In this manner the secondary coil is protected, with corresponding sealing of the tubular frame portion, from weathering influences and mechanical damage, and can make contact to a rechargeable battery (disposed, in particular, inside the tubular frame portion) without further penetration of the outer envelope of the tubular frame portion. For positioning of the secondary coil in accordance with the present invention inside the tubular frame portion, the assemblage can encompass a guide unit that ensures positioning of the secondary coil in thermally conductive coupling with the tubular frame portion, and may also receive the first signal processing unit. The result is to make available a compact production unit that can be introduced by the manufacturer or the user into the tubular frame portion of the vehicle.

The guide unit can also have a receptacle for an electrochemical energy reservoir (“battery”) with which the energy reservoir can also be coupled with good thermal conductivity to the tubular frame portion of the vehicle. This on the one hand offers the possibility of dissipating, via the tubular frame portion, waste heat occurring within the battery during a charging operation, and on the other hand (especially when outside temperatures are low), because of the thermal proximity of the energy reservoir and the secondary coil, heat generated by the secondary coil and/or by the signal processing unit can be used to bring the rechargeable battery to operating temperature.

The assemblage may have a primary coil, and is configured also to dispose the primary coil and the tubular frame portion of the vehicle coaxially with one another, and in that context to couple them to one another with good thermal conductivity. In other words, the tubular frame portion of the vehicle penetrates substantially at a right angle through a plane spanned by the windings of the primary coil and secondary coil. Regarding thermal coupling of the primary coil with the tubular frame portion, the statements made in connection with the secondary coil apply correspondingly. For magnetic coupling of the primary coil and secondary coil, the two coils can be disposed in the physical vicinity of one another on the tubular frame portion. In particular, a secondary coil disposed inside the tubular frame portion can encompass a ferrite core that may guide the magnetic field lines of the coils and concentrates them in the interior of the coils. This results in good coupling of the two coils, which increases the energy transfer efficiency.

The primary coil may be configured to be disposed outside the tubular frame portion. This yields an easy capability for creating a connection to the electrically drivable vehicle during a charging operation, by the fact that the primary coil is disposed on the tubular frame portion and is connected via an electrical lead to an electrical energy supply of an energy grid operator. Heat dissipation for the primary coil is moreover also provided in this manner by the ambient air and any condensation. The secondary coil as well can, in principle, be disposed outside the tubular frame portion, thereby yielding, for the secondary coil as well, the aforementioned advantages in terms of heat dissipation and rapid and reversible installation. Disposition of the secondary coil inside the tubular frame portion offers advantages, however, in the context of protecting the secondary coil from damage due to liquids and mechanical influences.

The assemblage can be configured to adjust the mutual mechanical coupling of the two coils, in particular by varying their spacing from one another along the tubular frame portion. For example, the coils can be moved away from and toward one another by way of a thread or a displaceable mount with the result that the magnetic coupling of the two coils changes, in particular for the case in which a ferrite core disposed inside one coil penetrates through both coils in a first position, whereas in a second position it penetrates through only one coil. It is thereby possible, for example, to optimize energy transfer depending on the vehicle. Intuitive and flexible influencing of the overall center of gravity of the vehicle can also be enabled by a flexible assemblage of this kind.

The assemblage can encompass a Hall sensor that is configured to measure a magnetic field at the tubular frame portion of the vehicle. For this, the Hall sensor can be disposed, for example, on an inner surface of the tubular frame portion in the physical vicinity of one coil or of both coils. The magnetic field, and thus energy transfer parameters during the charging operation, can be monitored using the Hall sensor. Alternatively, multiple Hall sensors can be provided, so that each Hall sensor substantially measures the magnetic field of a single coil. It is moreover self-evident that a different sensor that can measure a magnetic field in terms of orientation and intensity can also be used.

In a possible embodiment, the electrically drivable vehicle is a two-wheeled vehicle, in particular a bicycle or an electric scooter. Such vehicles are enjoying increasing popularity as a result of rising costs for fossil fuels, and moreover represent a possible measure against limited parking availability in population centers.

The tubular frame portion can be embodied in round tubular fashion, with the result that cylindrically wound coils can achieve ideal and direct thermal coupling to the tubular frame portion.

In order to connect the primary coil reversibly to the secondary coil for a charging operation, a plug connection between the tubular frame portion and the primary coil can be provided, which connection can additionally or alternatively be embodied as a snap/latch connection. An intuitive and uncomplicated approach to convenient connection of the two coils is thereby made available.

A second signal processing unit may be connected to the primary coil. The second signal processing unit may have a frequency converter and/or a rectifier. In this fashion the second signal processing unit can rectify a line voltage (AC voltage) and then, by way of the frequency converter, convert it to a frequency suitable for inductive energy transfer (for example, in the kHz range between 10 and 1000 kHz). The efficiency achievable for inductive transfer is thereby increased as compared with the 50-Hz signals made available by conventional line voltage sources. The signal processing units can encompass power semiconductors that are configured in particular to be connected with good thermal conductivity to the tubular frame portion. Effective heat discharge from the power semiconductors during the charging operation is thereby obtained, which increases the achievable charging speeds and avoids material damage.

According to a further aspect of the present invention, an electrically drivable vehicle, in particular a two-wheeled vehicle (e.g. bicycle, scooter) is made available that encompasses an energy reservoir disposed in particular in a tubular frame portion of the vehicle, as well as an assemblage for inductive energy transfer that has been extensively described above.

Exemplifying embodiments of the invention are described in detail below with reference to the accompanying drawings.

### BRIEF DESCRIPTION OF THE DRAWINGS

FIG. 1 shows a schematic view of an electrically drivable vehicle configured according to the present invention.

FIGS. 2 to 6 are schematic views of different exemplifying embodiments of assemblages according to the present invention.

FIG. 7 depicts a section through a further exemplifying embodiment of an assemblage according to the present invention.

FIG. 8 is a schematic view of an exemplifying embodiment of an assemblage according to the present invention in an assembled tubular frame portion assemblage.

### DETAILED DESCRIPTION

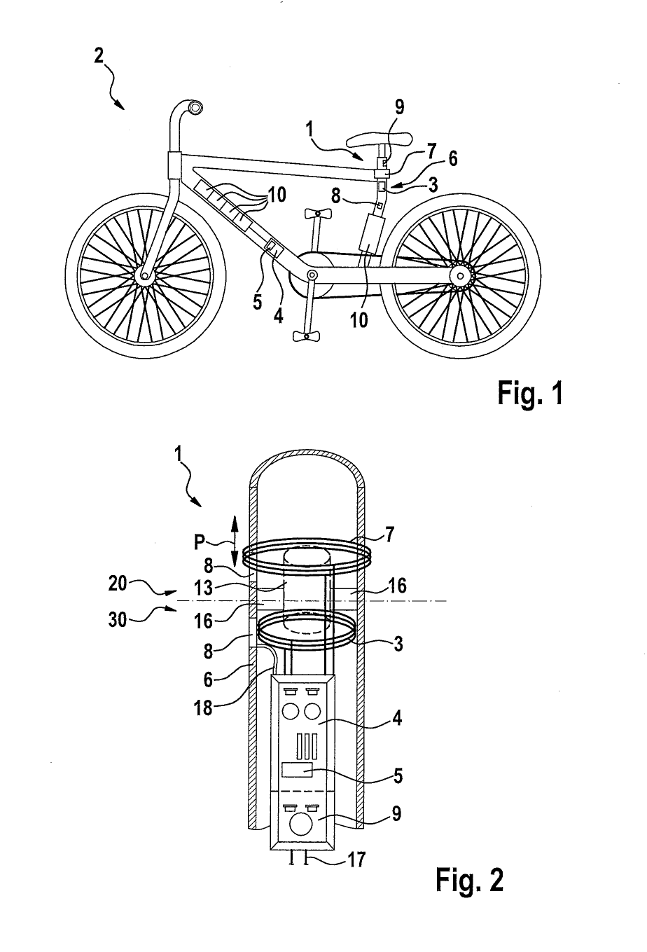

FIG. 1 shows an electrically drivable vehicle in the form of a bicycle 2. An assemblage 1 according to the present invention is provided in the region of the seat post of bicycle 2. A second signal processing unit 9 is disposed below the saddle in the physical vicinity of a primary coil 7, the latter encompassing the seat post. In other words, primary coil 7 is disposed outside a tubular frame portion of bicycle 2. Disposed below primary coil 7 inside a tubular frame portion 6 of bicycle 2 is a secondary coil 3 that is connected to an electrochemical energy reservoir 10. Also disposed on tubular frame portion 6 is a Hall sensor 8 that is configured to measure a magnetic field in order to determine the operating state of assemblage 1 according to the present invention. A first signal processing unit 4, having a rectifier 5 for secondary-side rectification of the signal received by secondary coil 3, is provided in the region of the bottom bracket of bicycle 2. The interaction and physical disposition of the aforementioned features are discussed in more detail with reference to the subsequent Figures.

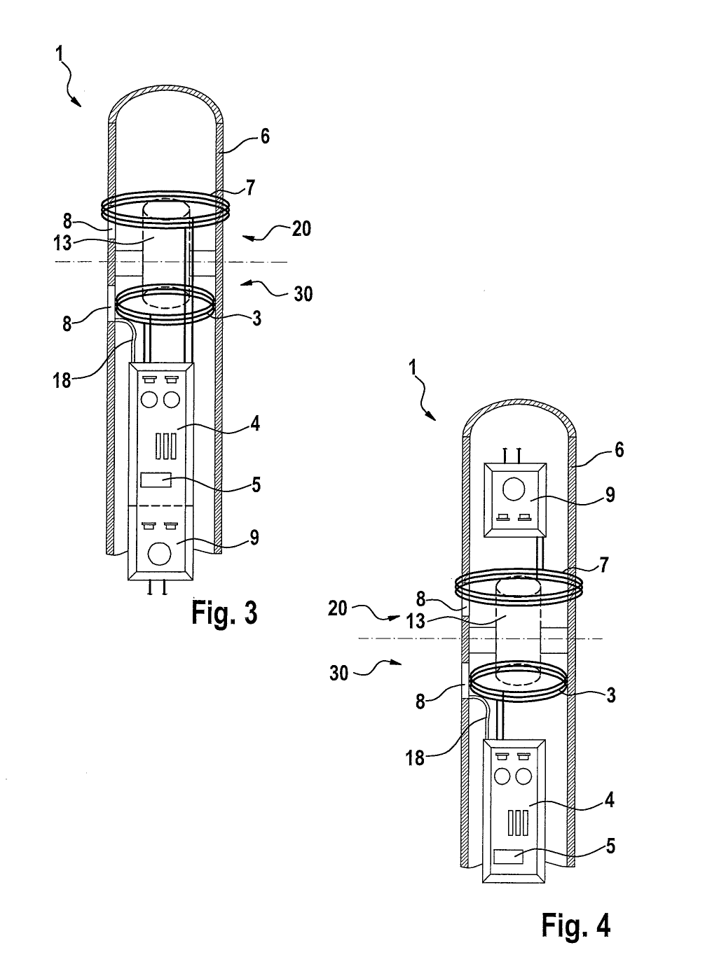

FIG. 2 shows a tubular frame portion 6 of bicycle 2 presented in FIG. 1. A primary coil 7 is placed onto tubular frame part 6 as indicated by arrow P. A ferrite rod 13 is disposed, by way of a holder 16, coaxially with tubular frame portion 6 inside the latter. Disposed inside tubular frame portion 6 on a side located opposite primary coil 7 with respect to ferrite rod 13 is a secondary coil 3 that is connected to a first signal processing unit 4 encompassing a rectifier 5. Leads 17 connect first signal processing unit 4 to an electrochemical energy reservoir (not depicted in FIG. 2) inside the frame of bicycle 2. Disposed at the level of primary coil 7 on tubular frame portion 6 is a Hall sensor 8 that is configured to measure a magnetic field induced by primary coil 7. A further Hall sensor 8 is correspondingly disposed in a contact region between tubular frame portion 6 and secondary coil 3. This Hall sensor 8 is connected via a sensor lead 18 to first signal processing unit 4 that carries out evaluation of the sensor signals. The assemblage depicted can be categorized, along a boundary extending through ferrite rod 13, a a transmitting unit 20 encompassing primary coil 7, and a receiving unit 30 encompassing secondary coil 3.

FIG. 3 shows the exemplifying embodiment depicted in FIG. 2 in a variant, according to which primary coil 7 is not disposed displaceably along the tubular frame portion axis. The features of the exemplifying embodiment depicted in FIG. 3 otherwise correspond identically to those depicted in FIG. 2.

FIG. 4 shows an exemplifying embodiment of an assemblage according to the present invention according to which first signal processing unit 4 and second signal processing unit 9 are disposed in different housings inside tubular frame portion 6. First signal processing unit 4 is associated physically with receiving unit 30, and second signal processing unit 9 physically with transmitting unit 20. First signal processing unit 4 is configured to rectify, by way of a rectifier 5, the signals received from secondary coil 3 in order to prepare them for storage in an electrochemical energy reservoir (not depicted) of bicycle 2. Second signal processing unit 9 is configured to convert line voltage signals (optionally through the intermediary of a rectifier) in order to prepare them for inductive energy transfer. Second signal processing unit 9 encompasses for this purpose a frequency generator that is configured to convert the rectified line signals to frequencies between 10 and 1000 kHz. Frequencies between 30 and 100 kHz, which may be in the region around 50 kHz, have proven particularly advantageous. The remaining features correspond to those explained in connection with FIGS. 2 and 3, and therefore will not be discussed further in order to avoid repetition.

FIG. 5 shows the exemplifying embodiment depicted in FIG. 4, which has been modified by disposing externally the second signal processing unit 9 previously disposed inside tubular frame part 6. Because primary coil 7 is also disposed outside tubular frame portion 6, a passthrough through the casing of tubular frame portion 6 becomes superfluous. Second signal processing unit 9 can be disposed, for example, in a housing (not depicted) that also encompasses primary coil 7, with the result that a particularly compact assemblage can be implemented. The remaining features correspond to those discussed in connection with FIG. 4.

FIG. 6 shows the assemblage depicted in FIG. 4 and discussed in connection therewith, transmitting unit 20 integrated into tubular frame portion 6 not being used (shown with dashed lines). In contrast thereto, an alternative (for example, retrofitted) second signal processing unit 9a is used in conjunction with an alternative primary coil 7a, in order to transmit energy inductively to secondary coil 3 without contact with tubular frame portion 6. The assemblage depicted in FIG. 6 represents a utilization scenario in which a bicycle 2 equipped according to the present invention is supplied with energy in an alternative manner on the basis of an alternatively present transmitting system 30a. For example, a defect in second signal processing unit 9 or in the supply lead can cause a user to select the approach to energy input that is depicted.

The alternatively present transmission system 30a can also be part of a publicly accessible charging station that the user utilizes in addition or alternatively to his or her own transmitting unit 20.

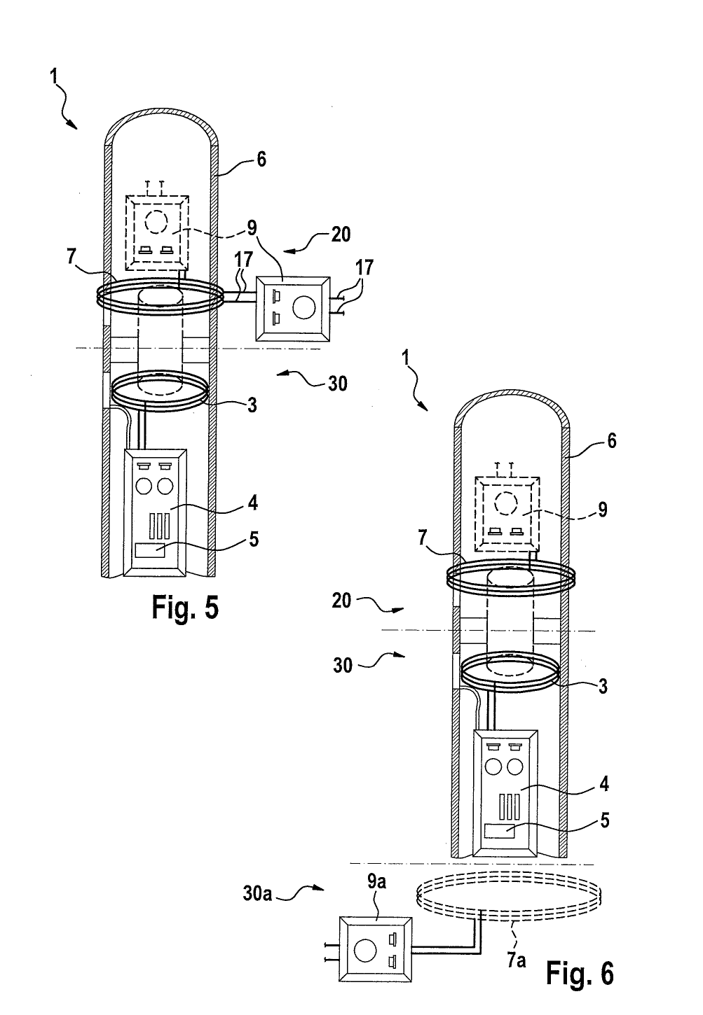

FIG. 7 shows a tubular frame part 6 that has a heat sink in tubular form produced from metal foam 26; embedded temperature sensors 12, Hall sensors 8, and power semiconductors 11 embedded in metal foam 26 via cooling paste 15 and/or electrical insulating washers are integrated into the metal foam 26. Power semiconductors 11 are electrically connected to circuit boards 14 provided in the cavity of the heat sink. Circuit boards 14 of transmitting unit 20 can be connected to primary coil 7 and to further temperature sensors 12 and Hall sensors 8 disposed in the region of primary coil 7, while circuit board 14 provided in receiving unit 30 is connected to a secondary coil 3 and to temperature sensors 12 and Hall sensors 8 provided in the region of secondary coil 3. In particular, the signals of sensors 12 and 8 can be used in a particular closed-loop control method to regulate the energy transfer between transmitting unit 20 and receiving unit 30.

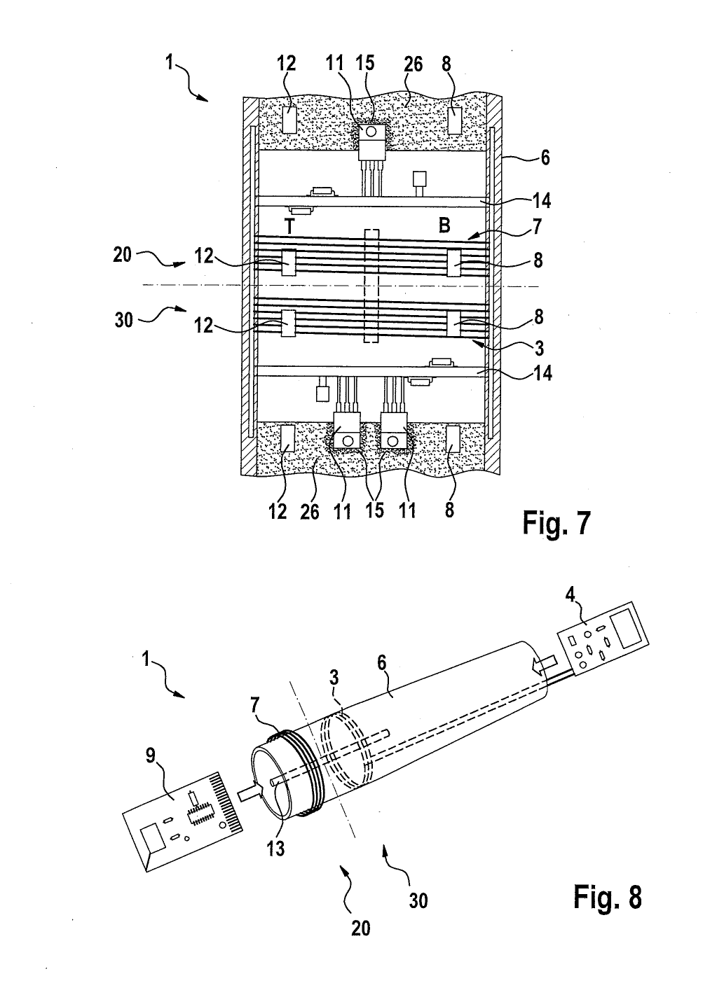

FIG. 8 shows an alternative exemplifying embodiment for a assemblage 1 according to the present invention, tubular frame portion 6 being embodied by a seat post of bicycle 2. Transmitting unit 20 encompasses a second signal processing unit, embodied as a circuit board, that is connected to a primary coil 7 disposed outside the seat post. A secondary coil 3 is disposed inside the seat post; both primary coil 7 and secondary coil 3 can be penetrated by a common ferrite rod 13. Secondary coil 3 is electrically connected to a circuit board of a first signal processing unit 4.

It is a central idea of the present invention to propose an assemblage for inductive energy transfer to an electrically drivable vehicle, which assemblage on the one hand is of maximally robust configuration by the fact that the assemblage can be disposed at least in part inside mechanically strong volumes of the vehicle, while on the other hand a displaceable relative position of a primary coil and a secondary coil makes possible adaptation of a transfer ratio (adaptable magnetic coupling). Contact with good thermal conductivity is also proposed between the coils used for inductive energy transfer and a tubular frame portion of the vehicle.

Although the aspects of the present invention and advantageous embodiments have been described in detail on the basis of the exemplifying embodiments explained in conjunction with the attached Figures of the drawings, modifications and combinations of features of the exemplifying embodiments illustrated are possible for one skilled in the art without departing from the region of the present invention, the range of protection of which is defined by the attached claims.

What is claimed is:

1. An assemblage for providing inductive energy transfer to an electrically drivable vehicle, comprising:
an assemblage arrangement, including:
a primary coil;
a secondary coil; and
a first signal processing unit configured to process the energy received from the secondary coil;
wherein the assemblage arrangement is configured to dispose the secondary coil and a tubular frame portion of the vehicle coaxially with one another, and in that context to couple them to one another with good thermal conductivity, the mutual magnetic coupling between the primary coil and the secondary coil being configured adjustably by varying their spacing from one another along the tubular frame portion.

2. The assemblage of claim 1, wherein the secondary coil is configured to be disposed inside the tubular frame section.

3. The assemblage of claim 1, wherein the assemblage arrangement is configured to dispose the primary coil and the tubular frame portion of the vehicle coaxially with one another, and in that context to couple them to one another with good thermal conductivity.

4. The assemblage of claim 3, wherein the primary coil is configured to be disposed outside the tubular frame portion, and the secondary coil is configured to be disposed outside or inside the tubular frame portion.

5. The assemblage of claim 1, wherein the assemblage encompasses a Hall sensor or another magnetic field sensor that is configured to measure a magnetic field at the tubular frame portion of the vehicle.

6. The assemblage of claim 1, further comprising:
a heat sink made of metal foam for thermal coupling, wherein at least one of a temperature sensor, a Hall sensor, and a power semiconductor is embedded, via a cooling paste in the metal foam, in the metal foam.

7. The assemblage of claim 1, wherein at least one the following is satisfied: (i) the vehicle is a two-wheeled vehicle, and (ii) the tubular frame portion is in the form of a round tube.

8. The assemblage of claim 3, wherein the primary coil is configured to be reversibly connected for a charging operation to the secondary coil, by at least one of a plug connection and a snap/latch connection.

9. The assemblage of claim 3, further comprising:
a second signal processing unit, encompassing a frequency converter and a rectifier, is coupled to the primary coil, the signal processing units encompassing power semiconductors that are configured to be connected with good thermal conductivity to the tubular frame portion.

10. An electrically drivable vehicle, comprising:
an energy reservoir, disposed in a tubular frame portion of the vehicle; and
an assemblage for providing inductive energy transfer to an electrically drivable vehicle, including an assemblage arrangement, including:
a primary coil;
a secondary coil; and
a first signal processing unit configured to process the energy received from the secondary coil;
wherein the assemblage arrangement is configured to dispose the secondary coil and a tubular frame portion of the vehicle coaxially with one another, and in that context to couple them to one another with good thermal conductivity, the mutual magnetic coupling between the primary coil and the secondary coil being configured adjustably by varying their spacing from one another along the tubular frame portion.

11. A method for providing inductive energy transfer between a transmitting unit and a receiving unit, the method comprising:
using an assemblage for providing inductive energy transfer to an electrically drivable vehicle, including:
an assemblage arrangement, including:
a primary coil associated with the transmitting unit;
a secondary coil associated with the receiving unit;
a first signal processing unit configured to process the energy received from the secondary coil, wherein the assemblage arrangement is configured to dispose the secondary coil and a tubular frame portion of the vehicle coaxially with one another, and in that context to couple them to one another with good thermal conductivity, the mutual magnetic coupling between the primary coil and the secondary coil being configured adjustably by varying their spacing from one another along the tubular frame portion;
a heat sink, for thermal coupling, made of metal foam, into which at least one of a temperature sensor and a Hall sensor is embedded;
wherein energy transfer between the transmitting unit and receiving unit is regulated as a function of signals of the at least one of the temperature sensor and the Hall sensor.
